(19) United States
(12) Patent Application Publication
(10) Pub. No.: US 2024/0208022 A1
(43) Pub. Date: Jun. 27, 2024

(54) MAGNETIC HAMMER COVER

(71) Applicant: Daniel J. Raymond, Saginaw, MI (US)

(72) Inventor: Daniel J. Raymond, Saginaw, MI (US)

(21) Appl. No.: 18/545,456

(22) Filed: Dec. 19, 2023

Related U.S. Application Data
(60) Provisional application No. 63/434,747, filed on Dec. 22, 2022.

(51) Int. Cl. B25D 1/02; B25D 1/06

(52) U.S. Cl. CPC B25D 1/02; B25D 1/06

(57) ABSTRACT

Another aspect of the present disclosure is related to a hammer that has a head with a striking face. The hammer also has a handle that extends generally perpendicularly away from the head. A cover can be detachably connected with the head of the hammer to cover the striking face. The cover also has a body that has a generally planar covering portion and a side wall that extends orthogonally away from the covering portion along a perimeter of the covering portion. The body is attachable with a hammer head in such a manner that the covering surface covers a striking surface of the hammer. The hammer also includes a magnet for magnetically holding fasteners.

### CROSS-REFERENCE TO RELATED APPLICATION

This utility application claims the benefit of U.S. Provisional Application No. 63/434,747 filed Dec. 22, 2022, titled “MAGNETIC HAMMER COVER”. The provisional application is incorporated by reference herein as if reproduced in full below.

### BACKGROUND

### 1. Field

The present invention is related generally to hammers and is more particularly related to covers that can be placed over the striking faces of hammers.

### 2. Related Art

In the construction industry, workers often require different hammers and various other tools for different applications. For example, a worker may carry a claw hammer, a stud finder, etc. This can be cumbersome and difficult for such a worker. There is a continuing need for tools to perform more operations or to perform such operations in a more efficient manner.

### SUMMARY

One aspect of the present disclosure is related to a hammer cover. The cover includes a body that has a generally planar covering portion and a side wall that extends orthogonally away from the covering portion along a perimeter of the covering portion. The body is attachable with a hammer head of a hammer with the covering portion covering a striking surface of the hammer. The hammer cover also includes a magnet for magnetically holding fasteners.

According to another aspect of the present disclosure, the magnet is a separate piece from the body.

According to yet another aspect of the present disclosure, the magnet is centrally located on the generally planar covering portion.

According to still another aspect of the present disclosure, the covering portion has a hexagonal shape.

According to a further aspect of the present disclosure, the body is made of a polymeric material.

According to yet a further aspect of the present disclosure, the body is made of rubber or a rubber-like material.

Another aspect of the present disclosure is related to a hammer that has a head with a striking face. The hammer also has a handle that extends generally perpendicularly away from the head. A cover can be detachably connected with the head of the hammer to cover the striking face. The cover also has a body that has a generally planar covering portion and a side wall that extends orthogonally away from the covering portion along a perimeter of the covering portion. The body is attachable with a hammer head in such a manner that the covering surface covers a striking surface of the hammer. The hammer also includes a magnet for magnetically holding fasteners.

According to another aspect of the present disclosure, the body of the cover is made of a material that has a lower hardness than a material of the head.

According to yet another aspect of the present disclosure, the body of the cover is made of a polymeric material.

According to still another aspect of the present disclosure, the striking face of the head and the covering portion of the cover both have similar shapes.

According to a further aspect of the present disclosure, the striking face of the head and the covering portion of the cover both have hexagonal shapes.

According to yet a further aspect of the present disclosure, the magnet has a cross-sectional area that is less than a cross-sectional area of the striking face.

According to still a further aspect of the present disclosure, the magnet is centrally located on the covering portion of the body of the cover.

According to another aspect of the present disclosure, the cover has a recess and wherein the magnet is received within the recess.

According to yet another aspect of the present disclosure, the magnet is made as a separate piece from the body of the cover.

### BRIEF DESCRIPTION OF THE DRAWINGS

These and other features and advantages of the invention will become more readily appreciated when considered in connection with the following description of the presently preferred embodiments, appended claims and accompanying drawings, in which:

FIG. 1 is a perspective view of a hammer with a hammer cover constructed according to an example embodiment of the present disclosure;

FIG. 2A is an exploded view of the hammer and the hammer cover from one perspective;

FIG. 2B is an exploded view of the hammer and the hammer cover from a different perspective than FIG. 2A;

FIG. 3 is a perspective view of the hammer with a first type of fastener pre-loaded onto the hammer cover; and

FIG. 4 is a perspective view of the hammer with a second type of fastener pre-loaded onto the hammer cover.

### DESCRIPTION OF THE ENABLING EMBODIMENTS

Referring to the Figures, wherein like numerals indicate corresponding parts throughout the several views, one aspect of the present invention is related to a hammer cover 20 that can provide the striking face of a hammer 22, such as a claw hammer, with magnetic properties, thereby allowing the user to more easily start nails in work pieces. The magnetic properties allow button nails, which are used for felt paper on a woof or for a weather barrier on walls, to be magnetically “stuck” to the hammer cover 20 for starting such nails.

The hammer 22 of the exemplary embodiment is a claw hammer that includes a head 24, which is made as a single, monolithic piece of metal (such as cast iron, steel, or titanium) and a handle 25 that extends perpendicularly away from the head 24. In the exemplary embodiment, the handle 25 is made of wood and is fixedly attached with the head 24. However, in some embodiments, the handle can be made of the same or a different metal than the head and may be made as a monolithic piece with the head or a separate piece from the head.

The head 24 includes a nose with a striking face 26 at one end for striking or impacting objects, such as nails. In the exemplary embodiment, the striking face 26 has a hexagonal shape. However, in some embodiments, the striking face could be circular in shape or have any suitable shape. Opposite of the striking face 26, the head 24 of the exemplary hammer 22 includes a pair of nail pulling claws 27. However, in some embodiments, the hammer could be a different style of hammer than a claw hammer, e.g., a ball peen hammer, a sledgehammer, or a brick hammer.

The hammer cover 20 includes a body that is made as a single piece and includes a generally flat (planar) base 28 (or covering portion) and a side wall 30 that extends orthogonally to the flat base 28 around its periphery to define a receiving space. The flat base 28 is shaped similarly to the striking face 26 of the head 24, and the side wall 30 is dimensioned to fit around a portion of the nose of the head 24 to establish a friction fit between the hammer cover 20 and the nose of the head 24 while fully covering the striking face 26. For example, if the striking face 26 has a hexagonal shape, as is the case in the exemplary embodiment, then the flat base 28 of the hammer cover 20 also has a hexagonal shape, and if the striking face has a circular shape, then the flat base of the hammer cover also has a circular shape. The specific dimensions of the flat base of the cover 20 also generally match the dimensions of the striking face 26.

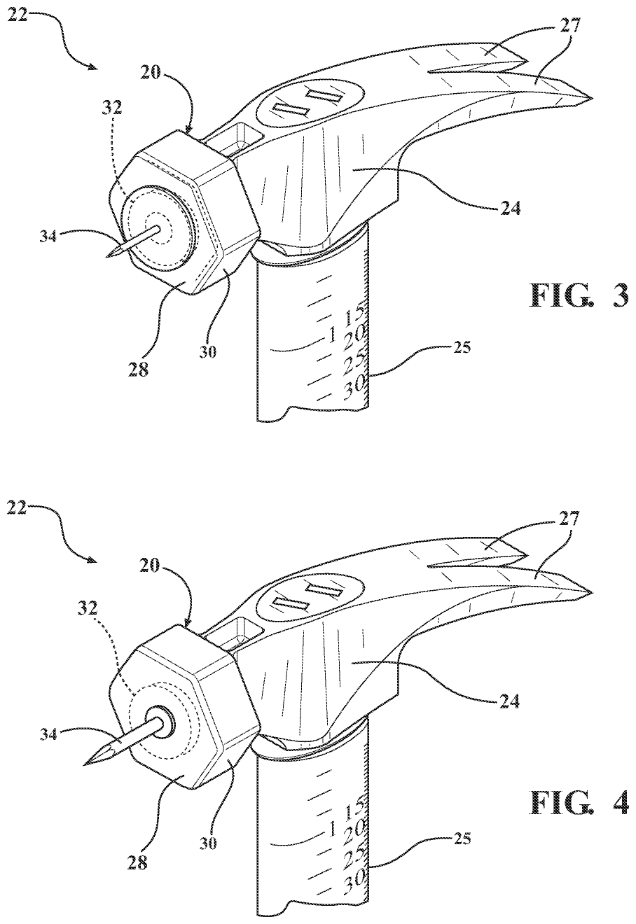

In the exemplary embodiment, the cover 20 either includes a magnet 32 for allowing the user to pre-stick fasteners, such as nails, to the striking face 26 prior to driving those fasteners into a work piece. The magnet 32 has a cross-sectional area that is less than that of the striking face 26, and the magnet 32 is centrally located on the cover 20 so that it is centrally located on the striking face 26 when the cover 20 is installed on the nose of the hammer 22. This allows the user to more quickly start and finish the nailing process. For example, FIG. 3 shows a first type of fastener 34 (specifically, a roofing nail) pre-loaded onto the cover 20 and FIG. 4 shows a different second type of fastener 34′ (a different type of nail) pre-loaded onto the hammer cover 20. As illustrated in both of these figures, when pre-loaded, the nail 34, 34′ is centered on the striking face. This gives the user additional accuracy when starting the nail 34, 34′. In some alternate embodiments, the cover itself is made fully or partially of a magnetic material that has been magnetized. The cover can be magnetized through any suitable magnetization process.

The material of the cover piece 20 can have a range of hardnesses, depending on a desired application. In some embodiments, the cover piece 20 can be made of a material that has a reduced hardness as compared to the striking face 26, thereby allowing the user to convert the hammer 22 from a hard blow hammer into a soft blow hammer by simply placing the cover piece 20 onto the nose of the head 24. In other embodiments, the cover piece 20 can have a greater hardness than the striking face 26 for applications where a striking face that has an increased hardness is desired. In other words, when affixed to the hammer 22, the cover 20 gives the hammer 22 a different striking hardness than the hammer 22 has when the cover 20 is not attached to the hammer 22.

In the exemplary embodiment, the material of the cover piece 20 is resiliently flexible, thereby allowing a user to install the hammer cover 20 by simply pressing the hammer cover 20 onto the nose of the hammer head 24. The user can remove the hammer cover 20 from the hammer 22 by peeling the hammer cover 20 off of the nose of the hammer head 24. This process is both simple and repeatable. In some embodiments, the hammer cover can be fixedly attached with the nose of the hammer head through other means, e.g., fasteners or magnetic means.

In the exemplary embodiment, the hammer cover 20 is made of a non-metallic material that has a reduced hardness as compared to the metal material of the hammer head 24. Thus, by installing the hammer cover 20 onto the nose of a hammer 22, a user is able to conveniently convert their hammer 22 from a hard blow hammer to a soft blow hammer for applications where a softer striking surface is beneficial, e.g., cabinetry or roofing applications. In some embodiments, the hammer cover 20 is made of a nylon or another polymeric material. In other embodiments, the hammer cover 20 is made of a rubber or rubber-like, elastomeric material. The hammer cover 20 may be made through any suitable process including, for example, an injection molding operation and/or a machining operation.

The magnet 32 may be placed between the hammer cover 20 and the striking face 26 of the hammer head 24. This allows a user to place a nail 34 or other type of fastener onto the hammer 22 and release the nail 34 while it remains on the hammer cover 20 through magnetic attraction prior to impacting that object onto a workpiece, as shown in FIGS. 5 and 6. The positioning of the magnet 32 between the striking face 26 and the hammer cover 20 also allows a user to use the hammer 22 as a stud finder by sensing the magnetic attraction between the magnet 32 and screws holding drywall to studs behind the drywall. In some embodiments, the hammer cover 24 may have a recess on an inner surface (facing towards the striking face 26 when the cover 20 is installed) of the flat to receive the magnet 32. The magnet 32 can be removed from the hammer cover 20 so that the hammer 20 can be used either with or without the magnet 32. The magnet 32 can either be shaped similarly to the striking face of the hammer 22 or can be shaped differently therefrom.

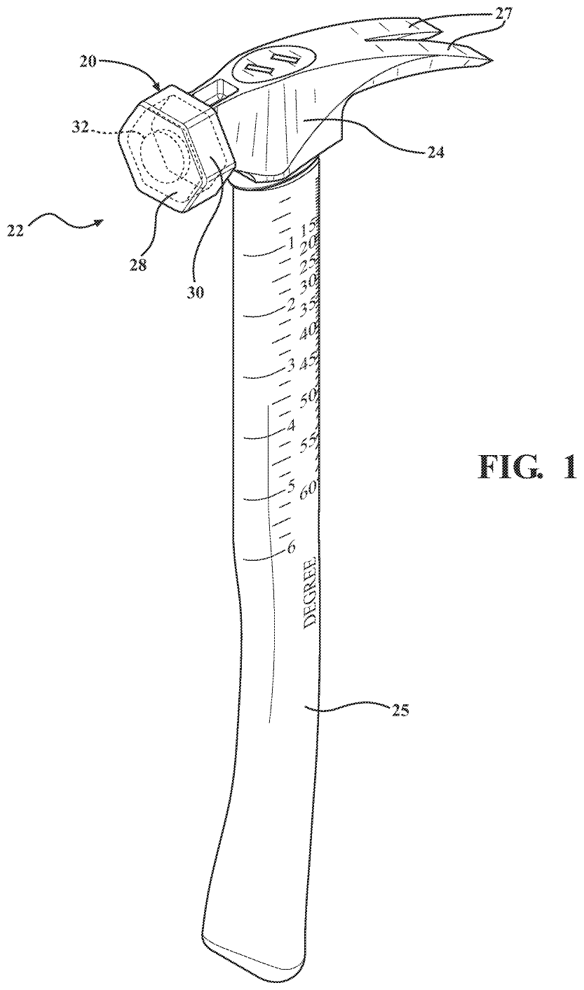

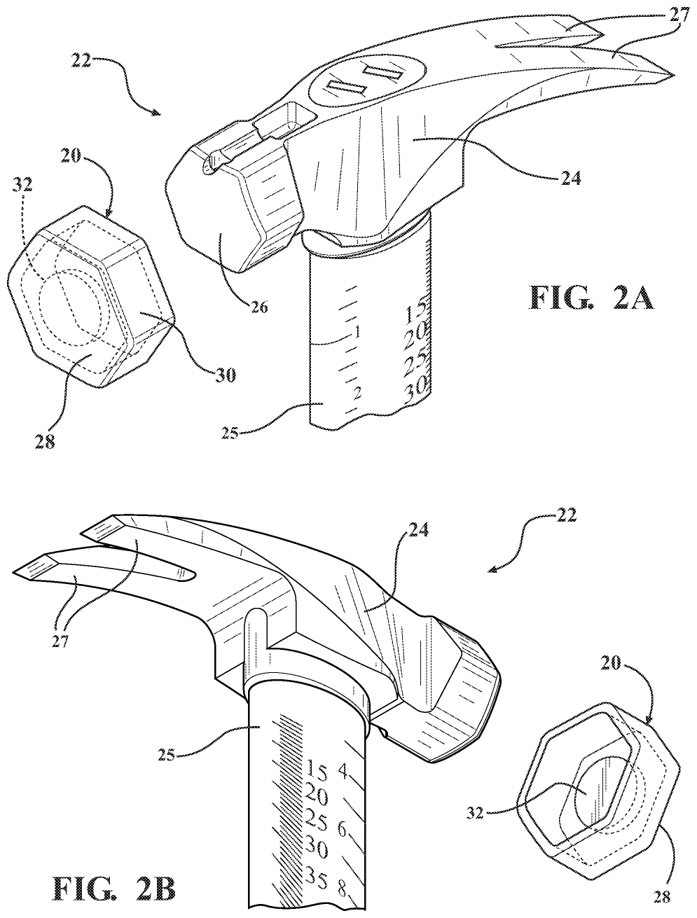

Obviously, many modifications and variations of the present invention are possible in light of the above teachings and may be practiced otherwise than as specifically described while within the scope of the appended claims. Additionally, it is to be understood that all features of all claims and all embodiments can be combined with each other as long as they do not contradict each other. Further, it is to be understood that certain terms of direction, such as upper, lower, top, and bottom are in reference to the orientation of the hammer as shown in FIG. 1 and are not intended to be limiting.

What is claimed is:

1. A hammer cover, comprising:
a body that includes a generally planar covering portion and a side wall that extends perpendicularly away from the covering portion along a perimeter of the covering portion, the body being attachable with a hammer head with the covering portion covering a striking surface of the hammer; and
a magnet for magnetically holding fasteners.

2. The hammer cover as set forth in claim 1, wherein the magnet is a separate piece from the body.

3. The hammer cover as set forth in claim 2, wherein the magnet is centrally located on the generally planar covering portion.

4. The hammer cover as set forth in claim 2, wherein the covering portion has a hexagonal shape.

5. The hammer cover as set forth in claim 1, wherein the body is made of a polymeric material.

6. The hammer cover as set forth in claim 1, wherein the body is made of rubber or a rubber-like material.

7. A hammer, comprising:
a head with a striking face;
a handle that extends generally perpendicularly away from the head;
a cover that can be detachably connected with the head of the hammer to cover the striking face, the cover including:
a body that has a generally planar covering portion and a side wall that extends orthogonally away from the covering portion along a perimeter of the covering portion, the body being attachable with a hammer head with the covering surface covering a striking surface of the hammer; and
a magnet for magnetically holding fasteners.

8. The hammer as set forth in claim 7, wherein the body of the cover is made of a material that has a lower hardness than a material of the head.

9. The hammer as set forth in claim 8, wherein the body of the cover is made of a polymeric material.

10. The hammer as set forth in claim 7, wherein the striking face of the head and the covering portion of the cover both have similar shapes.

11. The hammer as set forth in claim 10, wherein the striking face of the head and the covering portion of the cover both have hexagonal shapes.

12. The hammer as set forth in claim 7, wherein the magnet has a cross-sectional area that is less than a cross-sectional area of the striking face.

13. The hammer as set forth in claim 12, wherein the magnet is centrally located on the covering portion of the body of the cover.

14. The hammer as set forth in claim 7, wherein the cover has a recess and wherein the magnet is received within the recess.

15. The hammer as set forth in claim 7, wherein the magnet is made as a separate piece from the body of the cover.
